(19) United States
(12) Patent Application Publication
(10) Pub. No.: US 2025/0178554 A1
(43) Pub. Date: Jun. 5, 2025

(54) System and Method for Automated Vehicle Accident Detection and Safety-Protocol Activation

(71) Applicant: Vincent Loccisano, Wellesley, MA (US)

(72) Inventor: Vincent Loccisano, Wellesley, MA (US)

(21) Appl. No.: 19/041,348

(22) Filed: Jan. 30, 2025

(51) Int. Cl. B60R 21/013; H04L 67/125

(52) U.S. Cl. CPC B60R 21/013; H04L 67/125

(57) ABSTRACT

A system and method for detecting vehicle accidents uses on-board sensors to activate a series of safety protocols. The system detects vehicle accidents or collisions through various on-board sensors. Some on-board sensors used include a GPS module, water sensors, accelerometers, gyroscopes, impact sensors, temperature sensors, a yaw-rate sensor, a steering angle sensor, pressure sensors, wheel-speed sensors and on-board cameras.

### TECHNICAL FIELD

The present disclosure relates generally to vehicle-safety systems, and specifically to systems and methods for detecting vehicle accidents using on-board sensors, and initiating safety protocols for occupants and vehicle. The system and method is applicable to both electric and internal-combustion vehicles.

### BACKGROUND OF THE INVENTION

Safety challenges inherent in modern vehicles call for innovations that enhance occupant safety during and after collisions. Among safety challenges, batteries in electric vehicles (EVs) are subject to thermal runaway, a chain reaction within the battery in which a rising temperature causes additional heating, leading to a rapid release of energy, and potentially fire. Thermal runaway may result from external short-circuits caused by damage to wiring outside an EV's battery pack. Internal short circuits can result from impact from accidents or other damage to the battery pack, initiating thermal runaway. EVs are equipped with sophisticated battery-management systems (BMS) that monitor parameters like temperature, voltage and current to ensure safe operation and to prevent overcharging or overheating.

These problems are currently addressed by rapid cooling, fire blankets, and/or special containers. Rapid cooling is done by dousing the battery with large amounts of water to absorb heat and slow the thermal runaway process. Fire blankets or specialized containers are sometimes used to contain the fire in controlled environments or with smaller batteries than those used in a vehicle.

Modern vehicles have sensors and cameras that monitor aspects of the vehicle and its surroundings. Yaw-rate sensors, which measure a vehicle's rotation on its vertical axis, are used in stability-control systems. A steering-angle sensor measures the angle of a steering wheel. Accelerometers measure the vehicle's acceleration and deceleration. Gyroscopes measure a vehicle's rate of rotation. Impact sensors are designed to detect the force of an impact. They can be mechanical switches or electronic sensors that measure pressure or deformation of auto body components. Pressure sensors in doors detect the sudden pressure changes that occur during a side impact. Wheel-speed sensors monitor the rotational speed of each wheel, detecting impending accidents by sudden or uneven changes in wheel speed from skidding or loss of traction. Temperature sensors monitor the temperature of a battery compartment in an electric vehicle to provide early detection of overheating that may lead to thermal runaway. Water sensors detect water intrusion or submersion. A GPS module provides location data to assist emergency responders. Some vehicles integrate data from Advanced Driver Assistance Systems (ADAS) sensors such as cameras and radar to aid in accident detection. For example, sudden braking or swerving detected by these sensors may be combined with data from accelerometers to provide a fuller picture of an accident.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

Current technologies may not adequately address the multifaceted risks associated with vehicle accidents, particularly those involving high-voltage batteries in electric vehicles, as well as those involving fuel systems in combustion vehicles.

### SUMMARY OF THE INVENTION

The present invention is a system and method for detecting vehicle accidents using on-board sensors to activate a series of safety protocols. The system is designed to detect specific vehicle accidents through various on-board sensors and cameras. Some on-board sensors include a GPS module, water sensors, accelerometers, gyroscopes, impact sensors, temperature sensors, a yaw-rate sensor, a steering-angle sensor, pressure sensors, wheel-speed sensors and on-board cameras. Signals from each sensor are received in a central processing unit and the signals are processed by an application. A set of normal signals for each sensor, also referred to as a predetermined set of norms, is monitored by the application. When signals from one or more sensor(s) read outside of the set of norms, an accident is acknowledged. Depending on the sensors reading outside of a set of norms, a specific accident is determined and a specific accident protocol is initiated. For example, pressure sensors, impact sensors, and yaw rate sensor readings outside of a set of norms may signal an impact. An exit protocol and a light signal protocol may be initiated to allow passengers to exit the vehicle and to alert other drivers and emergency personnel as to the location of the vehicle.

When an accident or a collision is detected, the system initiates specific safety protocols designed to initiate solutions to specific situations. Signals from sensors are received in a central processing unit that processes data to determine whether an accident or collision has occurred, what type of accident has occurred and which protocol is to be initiated. In many protocols a GPS module provides location data that may be used to determine if the vehicle is in a safe location and may further be transmitted to emergency responders. Sensor data is confirmed with camera image data when applicable.

An example protocol reads signals from a water sensor to detect water intrusion or submersion. In this example, an egress protocol enables egress from a vehicle by rolling down windows, disengaging door latches, opening motorized doors or hatches, or unlatching a rear hatch. On-board cameras may be used to confirm the presence of water in or around the vehicle. A GPS module may be used to determine if the vehicle is on land or in water. Signals from a gyroscope may determine that the vehicle is right-side up and my open a sunroof to further support egress from the vehicle.

Signals from temperature sensors may determine that a battery or cell is of a higher temperature than a predetermined norm which may initiate a thermal-runaway protocol. A thermal-runaway protocol involves disconnecting a high-voltage battery in an electric vehicle to prevent electrical hazards. This protocol may deploy an on-board fire suppression mechanism if a battery compartment is damaged or if thermal runaway is detected. Cooling methods and/or fire suppression blankets, chemicals or similar tools and methods may be used to quell thermal runaway. For example, a furled fire suppression blanket may be unfurled to cover a battery compartment to contain and suffocate a fire in a set of batteries. A reservoir of coolant may be dispersed over the battery compartment or over a specific hot area.

Signals from yaw rate sensors, steering angle sensors, impact sensors, wheel speed sensors, pressure sensors, accelerometers, gyroscopes may be interpreted to determine that an accident has occurred. A fuel cut-off protocol shuts off a fuel system in an internal combustion vehicle to prevent fuel discharge or fire.

Signals from yaw rate sensors, steering angle sensors, impact sensors, wheel speed sensors, pressure sensors, accelerometers, gyroscopes may be interpreted to determine that an accident has occurred and that the vehicle is not moving. Images from on-board cameras are received in the central processing unit and processed to refine sensor data, to determine movement or non-movement of a vehicle, location of the vehicle on pavement or off-road. Camera data may, for example refine sensor data by determining that the vehicle is not moving by interpreting the imagery surrounding the vehicle, from forward-facing and rearward facing cameras, as changing or stationary. Information from a GPS module may determine that the vehicle is in a remote area or not on a road. A lighting-alert protocol activates exterior lights including headlights and hazard lights that signal for help and alert other drivers and emergency personnel of the location of the vehicle.

In many cases safety protocols involve the actuation of existing vehicle actuators that may be controlled through the vehicle CANbus. For example, windows may be automatically opened using existing electric window opening actuators. Doors may be unlocked using existing electric locks. Lights may be illuminated automatically by engaging existing electric switches.

### BRIEF DESCRIPTION OF DRAWINGS

FIG. 1 is a diagram illustrating a system of the embodiment.

FIG. 2 is a diagram illustrating a method of using the system of claim 1.

### DETAILED DESCRIPTION

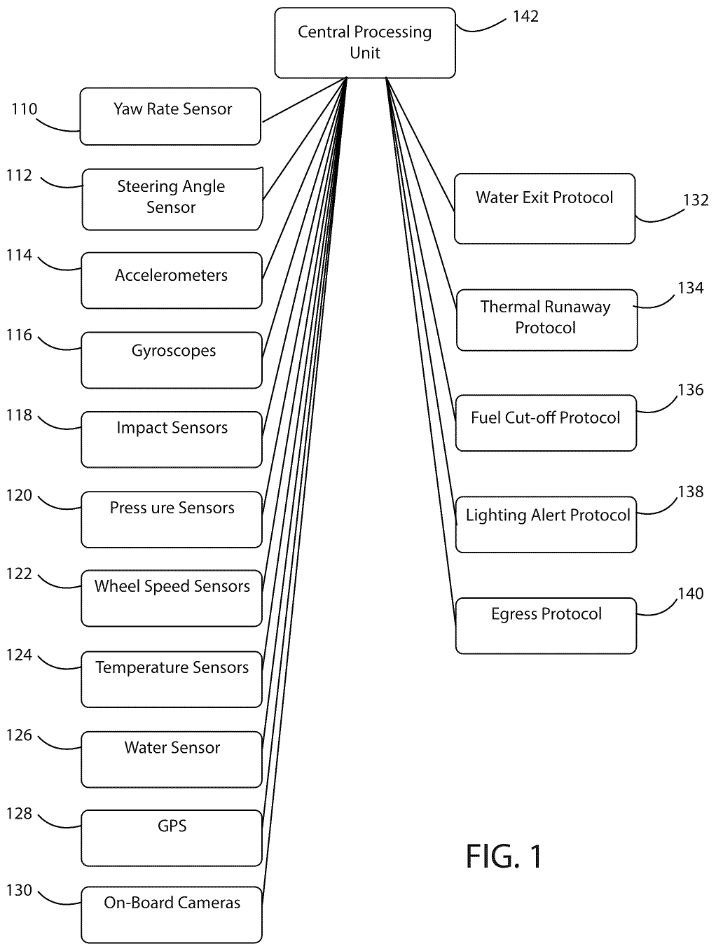

FIG. 1 is a diagram illustrating an example system of the disclosure. Sensors and cameras include a yaw-rate sensor 110, steering-angle sensor 112, accelerometers 114, gyroscopes 116, impact sensors 118, pressure sensors 120, wheel-speed sensors 122, temperature sensors 124, water sensors 126, GPS 128 and on-board cameras 130. These are continuously monitored by a central processing unit 142. One skilled in the art understands that a central processing unit 142, along with software applications, commonly store instructions for engaging protocols. The software application processes signals from sensors and cameras to detect signals inconsistent with normal driving activity. Processed signals are matched with likely accident situation(s) and specific accident protocols are chosen and initiated. For example, a yaw-rate sensor 110 signaling excessive yaw at a high speed may be calculated to determine when a vehicle can no longer remain stable under such conditions. In some embodiments, an initial reading may be compared with other sensor readings to confirm an accident occurrence. For example, readings outside of a preset norm from a yaw-rate sensor 110, steering angle sensor 112, gyroscope(s) 116 and GPS 128 may be combined to determine that a vehicle has spun off a road, even if there is no reading from an impact sensor 118 or pressure sensor 120. When the instructions stored in the central processing unit 142 detect sensor and/or camera readings outside a preset norm, a specific accident protocol is initiated. IN this case an egress protocol and a lighting alert protocol may be initiated.

When signals from sensors and cameras are processed and determined to be inconsistent with normal driving activity, the program in the central processing unit 142 initiates one or more protocols specific to the sensor readings and the likely accident situation. Protocols include a water-exit protocol 132, a thermal-runaway protocol 134, a fuel-cut-off protocol 136, a lighting-alert protocol 138 and an egress protocol 140.

In an example embodiment, a water-exit protocol 132 responds to a water-sensor 126 reading in which water in the vehicle is sufficient to indicate water submersion. This causes the program to initiate the water-exit protocol 132 which automatically opens windows to provide egress. In some embodiments, doors are automatically unlocked, a sunroof may be opened and motorized doors may be opened.

A thermal-runaway protocol 134 responds to excessive heat in a battery compartment measured by temperature sensors 124. The thermal runaway protocol 134 engages fire-suppression measures and may respond by dousing the battery compartment, or a specific portion of the battery compartment, with coolant stored in a reservoir. This protocol may actuate an apparatus to cover the battery compartment with a fire-suppression blanket by unfurling a furled fire-suppression blanket. In another example chemicals such as fire foam or other fire-suppression measures known in the art are dispersed over a battery compartment.

A fuel cut-off protocol 136 closes off fuel lines to reduce or eliminate fuel spillage. A lighting-alert protocol 138 engages vehicle lights such as hazard lights, headlights, tail lights and other indicators to signal for help. An egress protocol 140 automatically opens windows, unlocks doors and generally opens the vehicle for egress in water-submersion or accident situations.

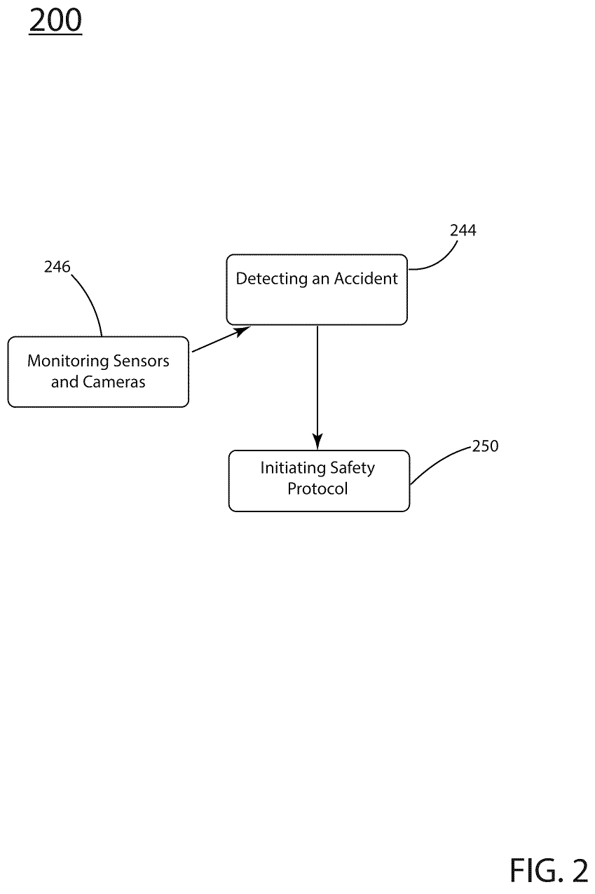

FIG. 2 is a diagram of a method of operating the system of FIG. 1. The software-application program stored in the central processing unit 142 (FIG. 1) monitors sensors and cameras 246 to detect an accident. (The term “accident” may refer to battery thermal runaway, water submersion, collision or any occurrence that may jeopardize the safety of passengers in the vehicle.) Upon detecting an accident 244 the program proceeds to activate a safety protocol 250. Safety protocols may be structured to respond to specific sensor readings.

In the aforementioned example where the vehicle has triggered the yaw-rate sensor 110, steering-angle sensor 112, gyroscope(s) 116 and GPS 128, signaling that the vehicle has experienced considerable yaw and has gone off the road, the instructions may initiate a fuel cut-off protocol 136, a lighting-alert protocol 138, and an egress protocol 140.

In the event of a significant reading from a water sensor 126 the program initiates an egress protocol 140, opening windows, unlocking doors and the like. This is critical to prevent occupants from becoming trapped, as water pressure outside the vehicle can make it difficult or impossible to open the doors once fully submerged. Opening windows ensures an exit route and increases the chances of a successful escape and rescue.

1. A system for detecting a vehicle accident and initiating at least one specific safety protocol comprising:
a central processing unit storing a software application program; and
said program electronically coupled with a set of sensors in the vehicle; wherein
said program monitors signals from the sensors to detect signals outside of a predetermined set of norms specific to accident situations, initiating at least one specific safety protocol according to the signals outside of the predetermined set of norms.

2. The system of claim 1 wherein:
the set of sensors includes at least one: yaw-rate sensor, steering-angle sensor, accelerometer, gyroscope, impact sensor, pressure sensor, wheel-speed sensor, temperature sensor, water sensor, and GPS.

3. The system of claim 1 wherein:
said program is further electronically coupled with the vehicle's on-board cameras; wherein
images from cameras are received in the central processing unit and processed to refine sensor data.

4. The system of claim 1 further comprising:
fire-suppression apparatus engaged with the battery compartment to suppress thermal runaway in the event of a battery-temperature sensor reading outside of a predetermined set of norms.

5. The system of claim 4 wherein;
the fire-suppression apparatus is a thermal blanket.

6. The system of claim 4 wherein:
the fire-suppression apparatus is a reservoir of coolant configured to douse a relatively hot section of a battery compartment.

7. The system of claim 1 wherein:
said at least one specific safety protocol includes a water-exit protocol, a thermal-runaway protocol, a fuel-cut-off protocol, a lighting-alert protocol, and an egress protocol.

8. A method of using the system of claim 1, the method comprising:
monitoring sensors continuously; and
detecting an accident based on one or more sensors' readings of data outside a predetermined set of norms;
initiating at least one specific safety protocol based on the sensor reading's determination of the type of accident.

9. A method for using the system of claim 1, the method comprising:
providing at least one specific safety protocol including an egress protocol comprising:
opening windows; and
unlatching doors; and
releasing seatbelts.

10. The method of claim 9 further comprising:
opening a sunroof; and
unlatching a rear hatch.

11. The method of claim 9 further comprising:
monitoring water detection sensors; and
initiating a water exit protocol upon water sensor reading outside of a predetermined set of norms; and
opening motorized doors.

12. The method of claim 11 further comprising:
monitoring GPS signals to locate the vehicle; and
determining if the vehicle is on land or in water.

13. The method of claim 12 further comprising:
monitoring forward-facing camera imagery to determine if at least a portion of the vehicle is in water.

14. A method for using the system of claim 1, the method comprising:
providing at least one specific safety protocol including a thermal-runaway protocol comprising:
detecting excessive heat from at least one from the set of sensors, in at least a portion of a battery compartment; and
disconnecting electrical lines to and from the battery.

15. The method of claim 14 further comprising:
transferring coolant from a reservoir to the portion of the battery compartment.

16. The method of claim 14 further comprising:
unfurling a fire-suppression blanket over the battery compartment.

17. A method for using the system of claim 1, the method comprising:
providing at least one specific safety protocol including a fuel cut-off protocol comprising:
detecting an impact from impact sensors; and
shutting off fuel lines; wherein
fuel is contained to prevent spillage.

18. A method for using the system of claim 1, the method comprising:
providing at least one specific safety protocol including a lighting alert protocol comprising:
detecting sensor readings outside of a predetermined set of norms; and
flashing vehicle exterior lights; wherein
the location of the vehicle is made prominent.

19. The method of claim 18 further comprising:
monitoring GPS signals to determine if the vehicle is on a road or off-road.

20. The method of claim 18 further comprising”
monitoring camera images to determine if the vehicle is surrounded by pavement or off-road material.
